(19) United States
(12) Patent Application Publication
(10) Pub. No.: US 2008/0156152 A1
(43) Pub. Date: Jul. 3, 2008

(54) Wrench Extension

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/051,102

(22) Filed: Mar. 19, 2008

Related U.S. Application Data
(63) Continuation-in-part of application No. 11/162,701, filed on Sep. 20, 2005.

(51) Int. Cl. B25B 23/16; B25B 13/48

(52) U.S. Cl. 81/177.2; 81/489

(57) ABSTRACT

A wrench extension includes a body having an end with a coupling section for releasably coupling with an open end of a handle of a wrench that has an adjustable head pivotably connected to the other end of the handle. The wrench extension further includes a retaining member mounted to the end of the body for securely clamping the open end of the wrench on the end of the body. The retaining member is movable relative to the body to allow coupling of the wrench extension with wrenches with variously sized open ends.

### CROSS REFERENCE

The present application is a continuation-in-part application of U.S. patent application Ser. No. 11/162,701, filed on Sep. 20, 2005, of which the entire disclosure is incorporated herein.

### BACKGROUND OF THE INVENTION

1. Field of the Invention

The present invention relates to a wrench extension. In particular, the present invention relates to a wrench extension for a wrench having an adjustable head on an end thereof.

2. Description of the Related Art

FIG. 12 of the drawings illustrates a conventional wrench 1 comprising a handle 3 and an adjustable head 2 pivotally mounted to the handle 3. The adjustable head 2 can be retained in a desired angular position relative to the handle 3 in response to the environmental conditions, allowing convenient operation. However, operation of the wrench 1 becomes difficult when the adjustable head 2 is at an angle greater than 45 degrees with the handle 3. In a case that the adjustable head 2 is at a right angle with the handle 3 shown in FIG. 1, holding of and application of force to the handle 3 would not be easy during the operation for driving a fastener for loosening or tightening purposes. The time required for complete loosening or tightening is relatively long and the efficiency is poor.

### SUMMARY OF THE INVENTION

In accordance with aspects of the present invention, a wrench extension comprises a body including a first end and a second end. The first end comprises a coupling portion adapted to releasably couple with an open end on an end of a handle of a wrench that has an adjustable head pivotably connected to another end thereof. The coupling portion comprises a smaller diametrical section and a larger diametrical section. The smaller diametrical section has a first side and a second side spaced at a distance L1. The larger diametrical section has a first arcuate section and a second arcuate section spaced at a distance ranging from L2 to L3. The open end of the wrench has a size ranging from a spacing between the first and second sides of the smaller diametrical section to a spacing between the first and second arcuate sections of the larger diametrical section. A retaining member is mounted to the first end of the body. The retaining member is movable relative to the body for securely and releasably clamping the open end of the wrench on the first end of the body.

Preferably, the first end of the body comprises a stop, allowing the open end of the wrench to be clamped between the retaining member and the stop.

Preferably, the coupling portion comprises a smaller diametrical section and a larger diametrical section extending coaxially from the second end to the stop.

Preferably, the larger diametrical section comprises an outer threading and the retaining member comprises an inner threading for threadedly engaging with the outer threading of the larger section.

Preferably, the restraining member comprises a plurality of anti-slip ribs on an outer periphery thereof.

Preferably, the wrench extension further comprises a washer between the retaining member and the stop. The open end of the wrench is securely clamped between the washer and one of the retaining member and the stop.

Preferably, the wrench extension further comprises an anti-slip rubber ring mounted to a side of the washer and facing one of the retaining member and the stop

Preferably, the wrench extension further comprising a handle cover mounted to the second end of the body for gripping comfort.

Preferably, L2 is two times as large as L1, L3 is three times as large as L1.

Other objectives, advantages, and novel features of the invention will become more apparent from the following detailed description when taken in conjunction with the accompanying drawings.

### BRIEF DESCRIPTION OF THE DRAWINGS

FIG. 1 is an exploded perspective view of a wrench extension in accordance with a first embodiment of the present invention.

FIG. 2 is an exploded perspective view of the wrench extension in accordance with a second embodiment of the present invention.

FIG. 3 is an exploded perspective view of the wrench extension in accordance with a third embodiment of the present invention.

FIG. 4 is an exploded perspective view of the wrench extension in accordance with a fourth embodiment of the present invention and a conventional wrench with an adjustable head.

FIG. 5A is a sectional view taken along line 5A-5A of FIG. 1.

FIG. 5B is a sectional view taken along line 5B-5B of FIG. 2.

FIG. 5C is a sectional view taken along line 5C-5C of FIG. 3.

FIG. 5D is a sectional view taken along line 5D-5D of FIG. 4.

FIGS. 6A-6C are partly-sectioned side views illustrating coupling of the wrench extension of the first embodiment and a wrench having an open end having a size ranging from a diameter of the smaller diametrical section to a diameter of the larger diametrical section.

FIGS. 7A-7C are partly-sectioned side views illustrating coupling of the wrench extension of the first embodiment and a wrench having an open end having a size ranging from a spacing between the first and second sides of the smaller diametrical section to a spacing between the first and second arcuate sections of the larger diametrical section.

FIGS. 8A-8C are partly-sectioned side views illustrating coupling of the wrench extension of the first embodiment and a wrench having an open end having a size ranging from a spacing between the first and second sides of the smaller diametrical section to a spacing between the first and second arcuate sections of the larger diametrical section.

FIGS. 9A-9C are partly-sectioned side views illustrating coupling of the wrench extension of the first embodiment and a wrench having an open end having a size ranging from a spacing between the first and second sides of the smaller diametrical section to a spacing between the first and second arcuate sections of the larger diametrical section.

FIG. 10 is a perspective view illustrating the wrench extension of the present invention with a washer.

FIG. 11 is a perspective view illustrating the wrench extension of the present invention with a handle cover at its end thereof.

FIG. 12 is a perspective view illustrating another modified embodiment of the wrench extension in accordance with the present invention.

### DETAILED DESCRIPTION OF THE PREFERRED EMBODIMENTS

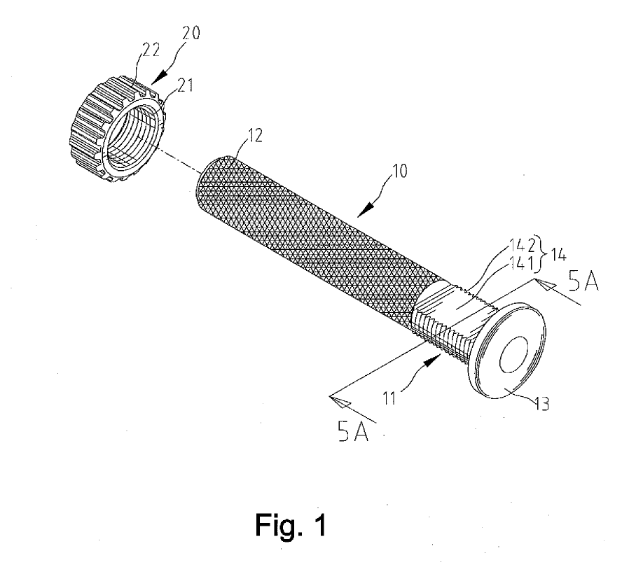

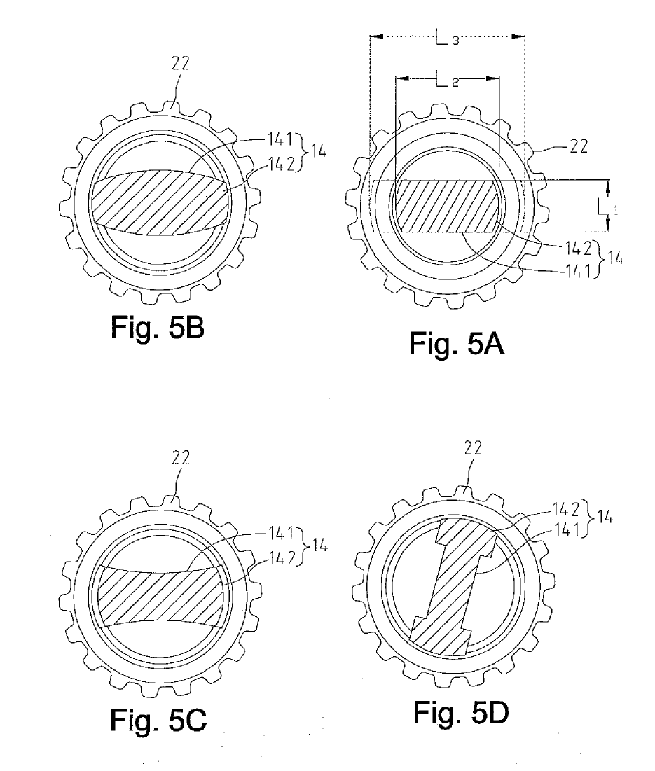

Referring to FIGS. 1, 5A and 6A-6C, a wrench extension in accordance with a first embodiment of the present invention comprises a body 10 and a retaining member 20. The body 10 comprises a first end 11 and a second end 12. The first end 11 of the body 10 comprises a stop 13 and a coupling portion 14. The first end 11, the second end 12 and the coupling portion 14 are being monolithic. The stop 13 is unremoveably attached to the coupling portion 14. The coupling portion 14 extends from the second end 12 to the stop 13. The first end 11, the second end 12, the coupling portion 14 and the stop 13 are being formed as an inseparable and contiguous piece. The coupling portion 14 includes a smaller diametrical section 141 and a larger diametrical section 142. The smaller diametrical section 141 includes a first side and a second side opposed to and spaced from the first side at a distance L1. In this embodiment, the first side is parallel to the second side. The larger diametrical section 142 includes a first arcuate section and a second arcuate section diametrically opposite to and spaced from the first arcuate section at a distance ranging from L2 to L3. Preferably, L2 is designed to be two times as large as L1, and L3 is three times as large as L1 so that spacing between the first and second sides is relatively small than that between the first and second arcuate sections. In FIG. 5A, the first and second arcuate sections are spaced at a distance L2, and the retaining member 20 has a retainer diameter equal to L2. Accordingly, if the first and second arcuate sections are spaced at a distance L3, the retainer diameter of the retaining member 20 will equal to L3.

Also, as best seen in FIG. 1, the first side and second side of the larger diametrical section 142 and the first and second arcuate sections of the larger diametrical section 142 extend coaxially from the second end 12 to the stop 13. Furthermore, the first and second arcuate sections of the larger diametrical section 142 extend from and directly interconnect the first and second sides of the smaller diametrical section 141. Also, the first and second arcuate sections have an end diameter equal to the retainer diameter of the retaining member 20 and include an outer threading extends from the second end 12 to the stop 13. Moreover, the second end 12 may be embossed to avoid slipping.

The retaining member 20 is mounted on the first end 11 of the body 10 and movable along a longitudinal direction of the body 10. In this embodiment, the retaining member 20 is a hollow member comprising an inner threading 21 for threadedly engaging with the outer threading of the larger diametrical section 142. Thus, the retaining member 20 can be manually turned to the desired longitudinal position relative to the body 10. Preferably, the retaining member 20 includes anti-slip ribs 22 on an outer periphery thereof to allow manual easy turning of the retaining member 20.

In a case that operation of an adjustable head 33 of a wrench 30 in a deep hole or restricted area is required, the adjustable head 33 is pivoted to and retained in a position at, e.g., a right angle with respect to a handle 31 of the wrench 30. The user may couple the wrench extension with an open end 32 of the wrench 30. Next, the retaining member 20 is turned until the open end 32 of the wrench 30 is securely clamped between the stop 13 of the body 10 and the retaining member 20. Thus, the wrench extension is coupled to the wrench 30 to move therewith, as the smaller diametrical section 141 is securely held between the jaws (not labeled) of the open end 32 of the wrench 30. It is note d that the body 10 of the wrench extension extends in a direction substantially perpendicular to that of the handle 31 of the wrench 30, the user may grip the second end 12 of the body 10 easily. An ergonomic design is thus provided. The force applied to the body 10 can be effectively transmitted to the handle 30. Thus, a fastener (not shown) engaged with the adjustable head 33 of the handle 30 can be effectively driven for tightening/loosening purposes. The operation time is shortened and the operational efficiency is improved.

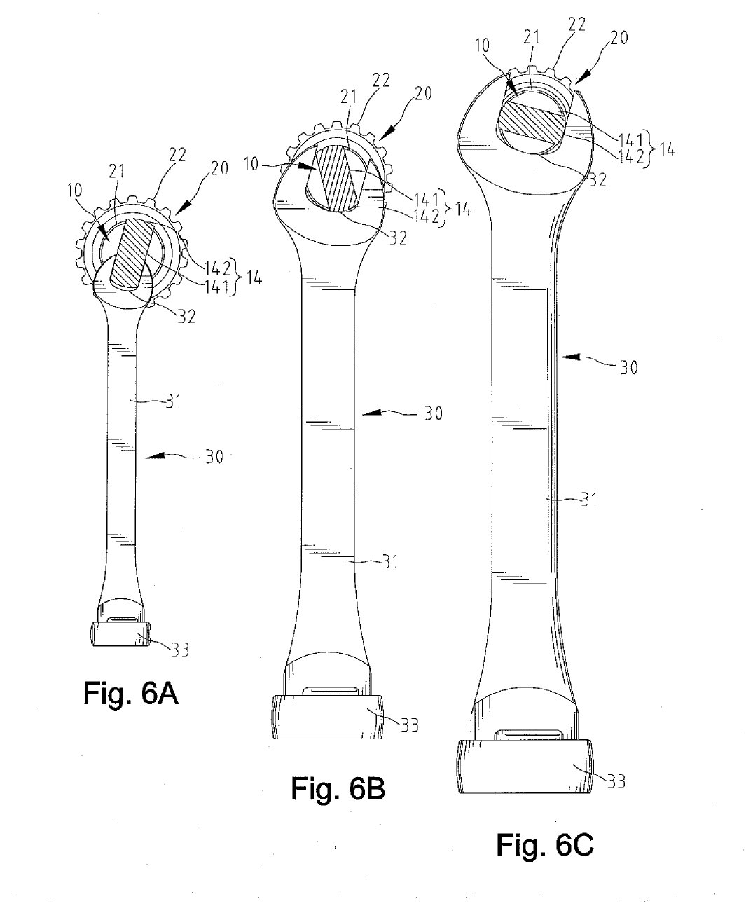

The open end 32 of the wrench 30 in FIG. 6A has a size equal to L1 or the spacing between the first and second sides of the smaller diametrical section 141 of the body 10. In a case that the open end 32 of the wrench 30 has a larger size equal to L3 or the spacing between the first and second arcuate sections of the larger diametrical section 142 of the body 10, the larger diametrical section 142 is securely held between the jaws of the open end 32 of the wrench 30, as shown in FIG. 6C.

In a case that the size of the open end 32 of the wrench 30 is between the spacing of the first and second sides of the smaller diametrical section 141 and the spacing of the first and second arcuate sections of larger diametrical section 142 of the body 10, the coupling portion 14 of the body 10 can be coupled to the open end 32 of the wrench 30 in a slanted state, as illustrated in FIG. 6B. Thus, the wrench extension in accordance with the present invention can be used to couple a wrench with an open end having a size ranging from the spacing of the first and second sides of the smaller diametrical section 141 to the spacing of the first and second arcuate sections of the larger diametrical section 142 of the body 10. Namely, the wrench extension in accordance with the present invention can be used with a set of wrenches with variously sized open ends.

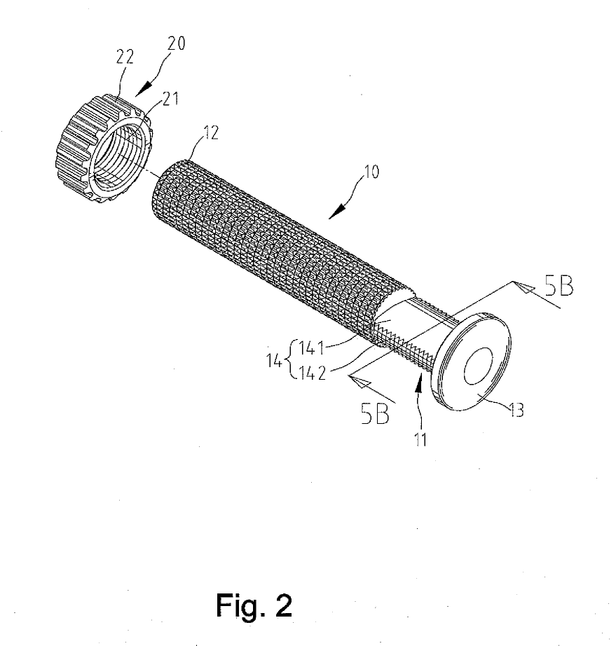

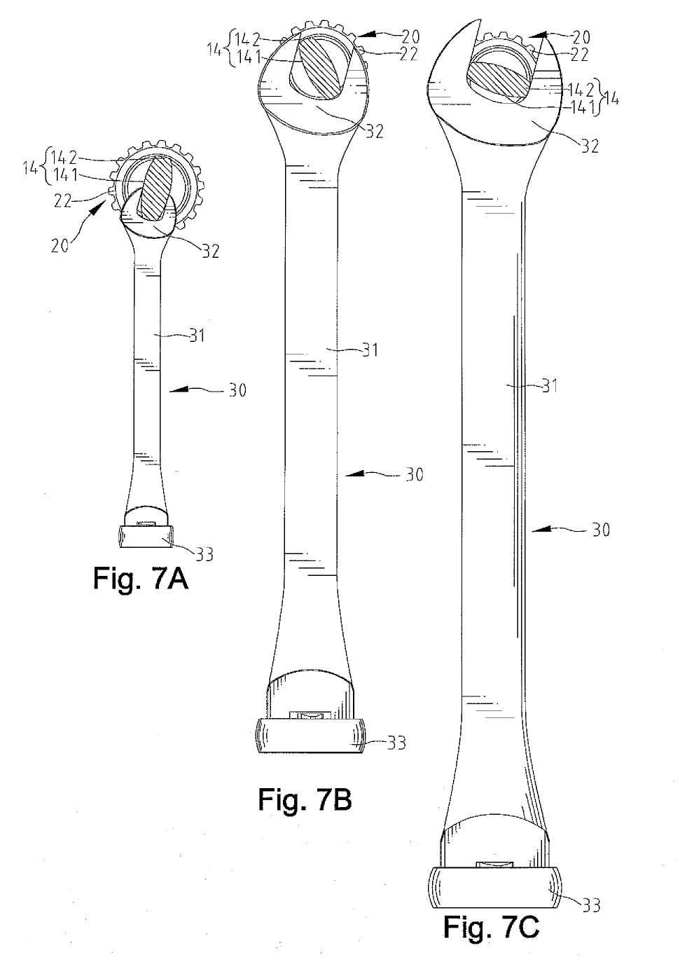

FIGS. 2, 5B, 7A-7C show a wrench extension in accordance with a second embodiment of the present invention, the wrench extension is similar to the prior embodiment except that the first and second sides of the smaller diametrical section 141 being arcuate outwardly.

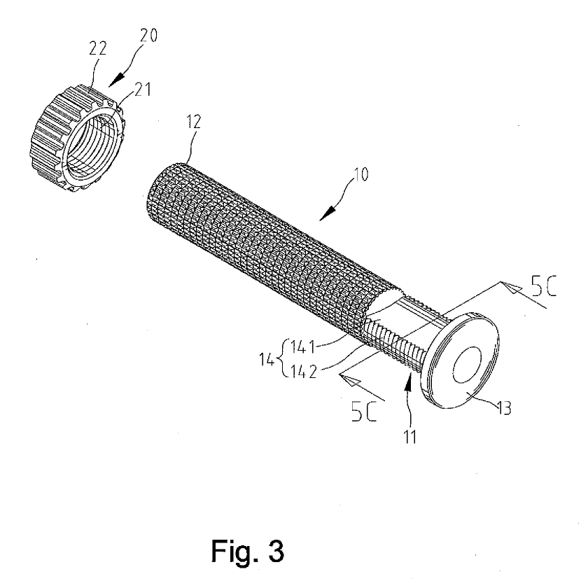

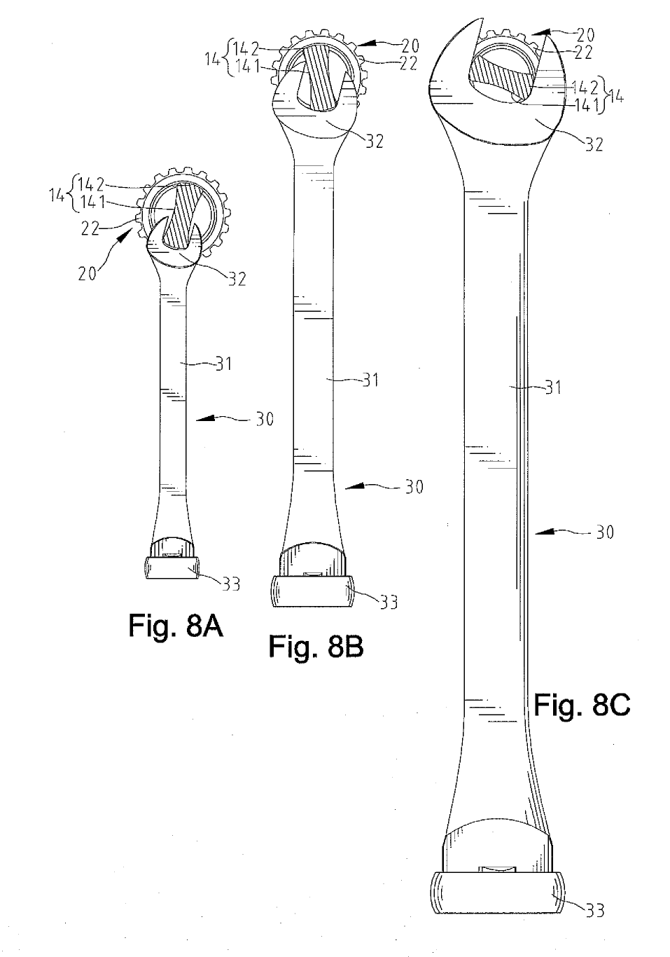

FIGS. 3, 5C, 8A-8C show a wrench extension in accordance with a third embodiment of the present invention, the wrench extension is similar to the first embodiment except that the first and second sides of the smaller diametrical section 141 being arcuate inwardly.

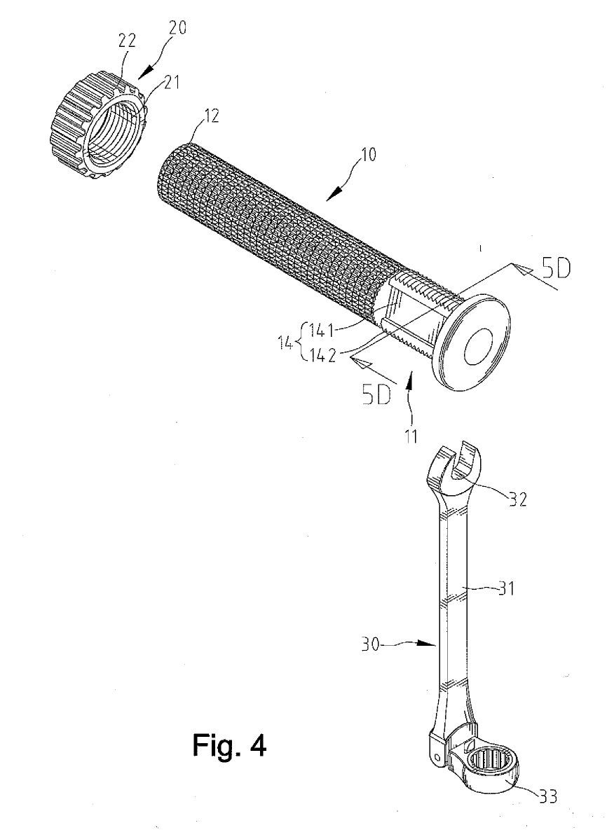

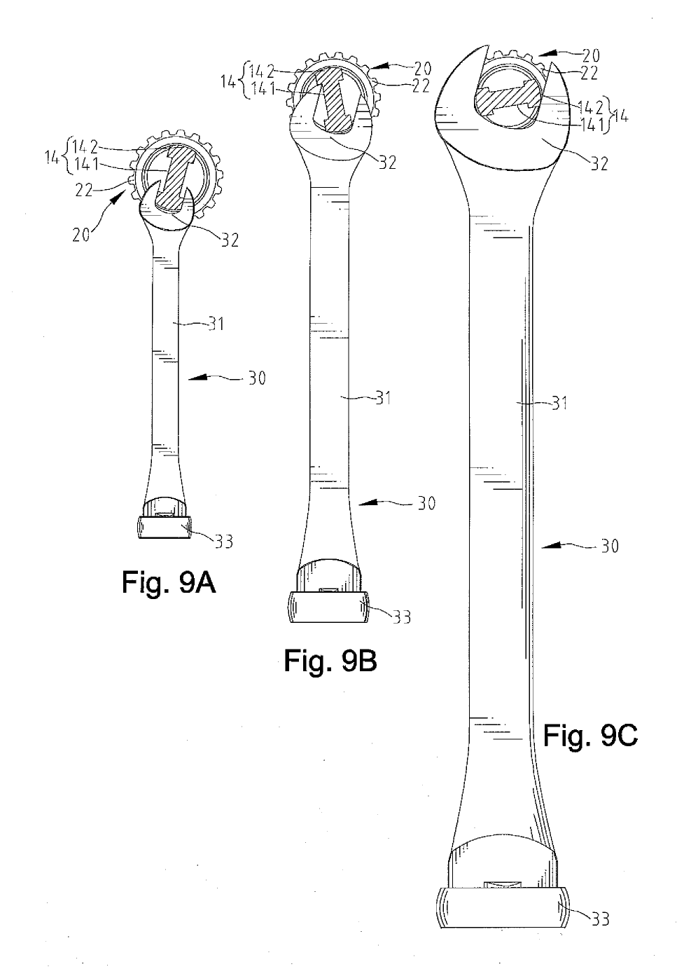

FIGS. 4, 5D, 9A-9C show a wrench extension in accordance with a fourth embodiment of the present invention, the wrench extension is similar to the first embodiment except that the first and second sides of the smaller diametrical section 141 having an inset.

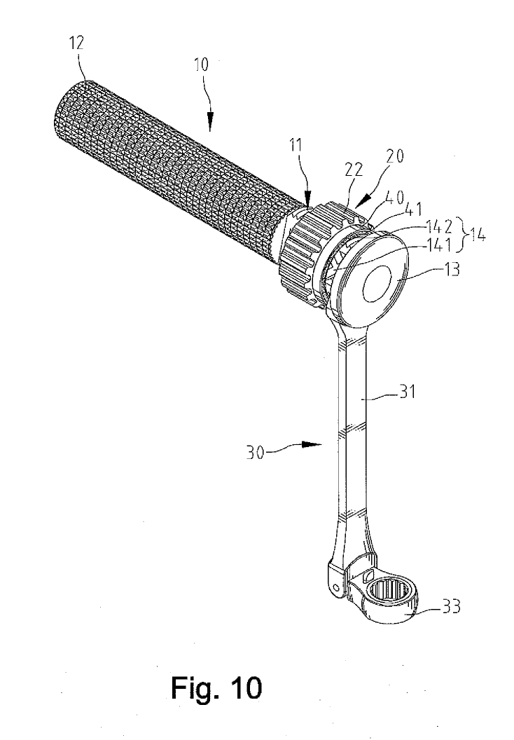

FIG. 10 illustrates a washer 40 adapted to be mounted between the retaining member 20 and the open end 32 of the wrench 30. Preferably, an anti-slip rubber ring 41 is mounted to a side of the retaining member 20 facing the stop 13. The washer 40 provides a firmer clamping effect for the open end 32 of the wrench 30. In an alternative arrangement, the washer 40 is mounted between the stop 13 and the other side of the retaining member 20.

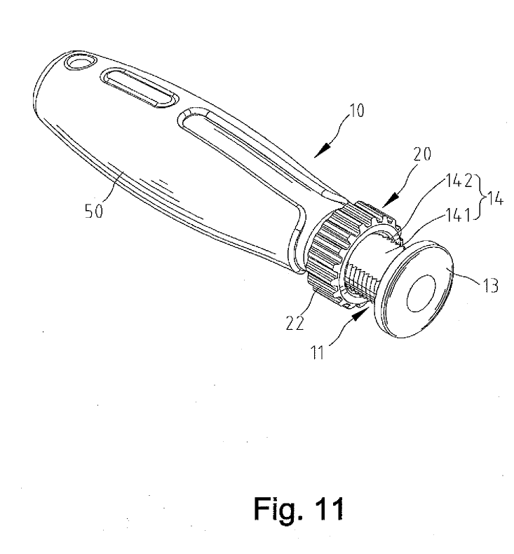

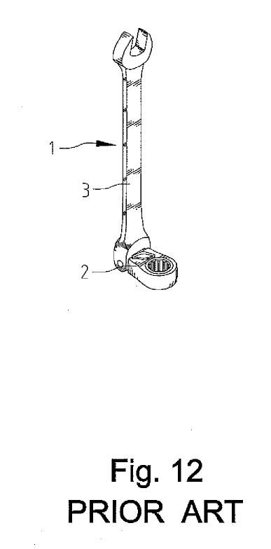

FIG. 11 illustrates the wrench extension further comprises a handle cover 50 mounted to the second end 12 of the body 10 for gripping comfort.

Although specific embodiments have been illustrated and described, numerous modifications and variations are still possible without departing from the essence of the invention. The scope of the invention is limited by the accompanying claims.

What is claimed is:

1. A wrench extension comprising:
a body comprising a first end and a second end, with the first end comprising a stop, with the first end further comprising a coupling section adapted to releasably couple with an open end of a handle of a wrench having an adjustable head pivotably connected to another end of the wrench, with the coupling section comprising a smaller diametrical section and a larger diametrical section, with the smaller diametrical section having a first side and a second side, with the larger diametrical section having a first arcuate section and a second arcuate section, with the first and second arcuate sections extending from and directly interconnecting the first and second sides, with the first and second arcuate sections being arcuate having an end diameter, with the first and second sides being spaced less than the end diameter, with the first arcuate section being diametrically opposed to and spaced from the second arcuate section, with the larger diametrical section comprising an outer threading extended from the second end of the body to the stop on the first and second arcuate sections; and
a retaining member comprising an inner threading for threadedly engaging with the outer threading of the larger diametrical section, with the inner threading defining a retainer diameter, with the end diameter equal to the retainer diameter, with the retaining member being moveable relative to the body toward and away from the stop allowing the open end of the wrench to be clamped between the retaining member and the stop so that the body drives the handle of the wrench.

2. The wrench extension as claimed in claim 1, with the first and second sides of the smaller diametrical section being parallel.

3. The wrench extension as claimed in claim 1, with the first and second sides of the smaller diametrical section being arcuate inwardly.

4. The wrench extension as claimed in claim 1, with the first and second sides of the smaller diametrical section being arcuate outwardly.

5. The wrench extension as claimed in claim 1, with the first and second sides of the smaller diametrical section having an inset respectively.

6. The wrench extension as claimed in claim 1, with the restraining member comprising a plurality of anti-slip ribs on an outer periphery of the retaining member.

7. The wrench extension as claimed in claim 1, with the retaining member being intermediate the stop and the second end of the body.

8. The wrench extension as claimed in claim 7, with the first end, the second end and the coupling portion being monolithic, with the stop unremovably attached to the body, with the first end, the second end, the coupling portion and the stop all formed as an inseparable and contiguous piece.

9. The wrench extension as claimed in claim 8, further comprising a washer between the retaining member and the stop, with the open end of the wrench being securely clamped between the washer and one of the retaining member and the stop.

10. The wrench extension as claimed in claim 9, with the wrench extension further comprising an anti-slip rubber ring mounted to a side of the washer and facing one of the retaining member and the stop.

11. The wrench extension as claimed in claim 8, with the wrench extension further comprising a handle cover mounted to the second end of the body for gripping comfort.

12. A combination comprising:
a wrench comprising a handle, an open end on a first end of the handle, and an adjustable head on a second end of the handle, the adjustable head being retainable in a desired angular position relative to the handle; and
a wrench extension comprising:
a body comprising a first end and a second end, with the first end of the body comprising a stop, with the first end further comprising a coupling section releasably coupling with the open end of the wrench, with the coupling section comprising a smaller diametrical section and a larger diametrical section, with the smaller diametrical section having a first side and a second side, with the larger diametrical section having a first arcuate section and a second arcuate section, with the first and second arcuate sections extending from and directly interconnecting the first and second sides, with the first and second arcuate sections being arcuate having an end diameter, with the first and second sides being spaced less than the end diameter, with the first arcuate section being diametrically opposed to and spaced from the second arcuate section, with the larger diametrical section comprising an outer threading extended from the second end of the body to the stop on the first and second arcuate sections; and
a retaining member mounted to the first end of the body, with the retaining member comprising an inner threading for threadedly engaging with the outer threading of the larger diametrical section, with the inner threading defining a retainer diameter, with the retaining member being moveable relative to the body for securely and releasably clamping the open end of the wrench on the first end of the body, with the end diameter equal to the retainer diameter of the retaining member, with the retaining member being moveable relative to the body toward and away from the stop allowing the open end of the wrench to be clamped between the retaining member and the stop, with the wrench extension driving the handle and the adjustable head of the wrench.

13. The combination as claimed in claim 12, with the first end, the second end and the coupling portion being monolithic, with the stop unremoveably attached to the body, with the first end, the second end, the coupling portion and the stop all formed as an inseparable and contiguous piece, with the retaining member located intermediate the stop and the second end of the body.

14. The combination as claimed in claim 12, with the body extending between the first and second ends in a direction substantially perpendicular to an extending direction of the handle between the first and second ends of the wrench.

15. The combination as claimed in claim 12, with the wrench extension further comprising a handle cover mounted to the second end of the body for gripping comfort.

16. The combination as claimed in claim 12, with the open end of the wrench having a size ranging from a diameter of the smaller diametrical section to a diameter of the larger diametrical section.

17. The combination as claimed in claim 12, with the first and second sides of the smaller diametrical section being parallel.

18. The combination as claimed in claim 12, with the first and second sides of the smaller diametrical section being arcuate inwardly.

19. The combination as claimed in claim 12, with the first and second sides of the smaller diametrical section being arcuate outwardly.

20. The wrench extension as claimed in claim 12, with the first and second sides of the smaller diametrical section having an inset respectively.
